(19) United States
(12) Patent Application Publication
(10) Pub. No.: US 2003/0142758 A1
(43) Pub. Date: Jul. 31, 2003

(54) Radio transmitter-receiver

(76) Inventors: Mikio Sakaue, Tokyo (JP); Hidenori Tomishima, Tokyo (JP)

Correspondence Address: Arent Fox Kintner, Plotkin & Kahn, Suite 600, 1050 Connecticut Avenue NW, Washington, DC, 20036-5339, US

(21) Appl. No.: 10/276,224

(22) PCT Filed: Feb. 20, 2002
(86) PCT No.: PCT/JP02/01447

(30) Foreign Application Priority Data
Jun. 26, 2001 (JP) 2001-230565

(51) Int. Cl. H04L 27/04

(52) U.S. Cl. 375/295; 375/316

(57) ABSTRACT

The present invention relates to a radio transmitter-receiver and its object is to provide a frequency diversity communication device which can synthesize two carrier waves by one demodulation circuit without requiring any means for changing over the carrier waves and judging the receiving conditions.

The present invention achieves this object by the following means.

The two carrier waves are received at the same time, and they are respectively converted by a frequency converter to intermediate frequencies whose center frequencies in modulation are the same, to be demodulated. Thereby, a circuit for selecting the carrier wave becomes unnecessary and only one demodulation circuit is necessary since the carrier waves are synthesized before demodulated.

In order to remove beat occurring in the intermediate frequencies of the receiver through the above means, the transmitter performs frequency conversion with the same polarity for the two carrier waves by a baseband signal except a transmitting signal.

The present invention realizes a small-sized and low-priced radio transmitter-receiver having a frequency diversity function and widens the utilization range of radio communication.

### TECHNICAL FIELD

The present invention is utilized in a radio communication device.

### BACKGROUND ART

Interference by radio waves other than a desired wave has to be minimized as much as possible in order to obtain a desired communication distance in radio communication. In a general living space, there exist reflections of radio waves due to the ground, buildings, and so on, and multipath caused by them is unavoidable. The multipath causes amplitude fluctuation of the radio waves which is called fading.

One method of reducing the influence of this fading is frequency diversity, which utilizes the fact that occurrence conditions of the fading differ depending on frequency difference to reduce the fading in such a manner that carrier waves having a plurality of frequencies are transmitted and they are selected or synthesized.

In conventional devices, as a method of synthesizing the plural carrier waves, such a method or the like has been used in which the carrier waves are synthesized after demodulated to baseband signals by a plurality of receiving circuits respectively, or the carrier wave to be received is changed over by one receiver according to the receiving conditions. These devices are complicated because of the need for a receiving circuit (demodulation circuit) for each frequency, the need for a means for changing over the carrier waves and a means for detecting and judging the receiving conditions, and so on.

As a means for solving this, there is an example where, in a frequency diversity communication device using the two carrier waves, the frequencies of the carrier waves or the local frequency of a receiver are(is) so set that the difference in center frequencies in modulation between an intermediate frequency to which the frequency of a first carrier wave is converted and an intermediate frequency to which the frequency of a second carrier wave is converted becomes a half of or bigger than the cutoff frequency of a baseband filter of the receiver, and the two carrier waves are synthesized at the intermediate frequency.

In this case, it is not necessary to change over the carrier waves, judge the receiving conditions, and so on, but high stability is demanded for an oscillation circuit in order to fixedly maintain the difference in the center frequencies between the aforesaid intermediate frequencies, so that the circuit is complicated and high-precision parts need to be used.

### SUMMARY OF THE INVENTION

The object to be attained by the present invention is to provide a frequency diversity communication device without using any high-precision part and with a simple circuit, the frequency diversity communication device being able to synthesize two carrier waves with one demodulation circuit without requiring any means for judging receiving conditions and any means for changing over the carrier waves in its receiver.

As a means for attaining this object, in the present invention, the two carrier waves are received at the same time, frequency-converted to intermediate frequencies respectively whose center frequencies in modulation are the same, synthesized, and demodulated. Specifically, the two carrier waves which are frequency-modulated with reverse polarities to each other are frequency-modulated to the same intermediate frequency, one of them in an upper heterodyne and the other one in a lower heterodyne so that the two carrier waves have one intermediate frequency with the same modulation polarity. When this is demodulated, a circuit for selecting the carrier waves becomes unnecessary to eliminate the necessity of making judgment for changing over, and furthermore, only one demodulation circuit is necessary since they are synthesized before being demodulated.

But, when the two carrier waves are synthesized at the intermediate frequency, a problem occurs if they are only synthesized in a simple manner. Assuming that the frequencies of the two carrier waves are f₁, f₂ and the local frequency of the receiver f_{LO}=(f₁+f₂)/2, the conversion is so performed that the intermediate frequencies of the receiver become one intermediate frequency f_{IF}, where | f₁−f_{LO1}|=| f₂−f_{LO2}|=f_{IF}, and they are synthesized. But, in actual practice, since an oscillator on a transmitting end and a local oscillator on a receiving end differ from each other, it is impossible to accurately obtain f_{LO}=(f₁+f₂)/2 so that the intermediate frequencies having two values | f₁−f_{LO}|=f_{IF1} and | f₂−f_{LO2}|=f_{IF2} are synthesized to cause beat (amplitude fluctuation) of the frequency difference between f_{1F1} and f_{1F2}. When f_{IF1}, and f_{IF2} have the same amplitude, the amplitude of the synthesized intermediate frequency sometimes become zero, which gives a great influence on reception. FIG. 1 shows this state. It is shown that a part of the intermediate frequency where the amplitude is made small due to the beat is not accurately demodulated so that a pulse which is supposed to be regenerated is lacking.

The conventional art which is introduced in the Background Art is a method in which the frequencies of the carrier waves or the local frequency of the receiver are(is) so set that the difference in center frequencies between the intermediate frequencies becomes a half of or bigger than the cutoff frequency of the baseband filter of the receiver, and aims at removing the influence of this beat.

In the present invention, in order to eliminate the influence of this beat on the intermediate frequency, frequency modulation with the same modulation polarity is performed for the two carrier waves by a second baseband signal except a transmission baseband signal on the transmitting end.

FIG. 2 schematically shows the frequency spectrum of the carrier waves outputted from a transmitter of the present invention. The frequency modulation is performed by a first baseband signal fₛₗ, which is a transmitting signal to obtain two carrier waves f₁, f₂ whose modulation polarities are different from each other. The frequency modulation with the same polarity is performed for these two carrier waves by the second baseband signal fₛ₂.

The principle is explained in detail in FIG. 3. Here, it is assumed that the modulation by the first baseband signal is not performed to make the explanation easily understandable. As is previously described, assuming that the frequencies of the two carrier waves are f₁, f₂ and the local frequency of the receiver f_{LO}=(f₁+f₂)/2, the intermediate frequencies | f₁ f_{Lo1}=f_{IF1} and | f₂−f_{LO2}|=f_{IF2} of the receiver become the same frequency with the reversed modulation polarities. This is because the frequencies f₁, f₂ of the carrier waves which have been frequency-modulated by the second baseband signal with the same polarity and with the frequency shift f_{D} are frequency-converted, one of them in an upper heterodyne and the other one in a lower heterodyne.

Assuming that the waveform of the second baseband signal is a square wave, since a beat frequency becomes an instantaneous frequency expressed as | f_{If1}−f_{IF2}|, the beat frequency becomes outside the band of the baseband filter in a long time by the setting of f_{D} so that it can be removed. The shift time of the square wave is very short compared with the cycle of the first baseband signal so that the beat occurring during that time can also be removed by the baseband filter.

Further, FIG. 4 shows the state in which the modulation by the first baseband signal and the modulation by the second baseband signal coexist. The modulation polarities of f_{IF1} and f_{IF2} by the second baseband signal are reverse to each other so that the second baseband signal is cancelled out and does not appear in the output even when it is demodulated.

Even in the case when either one of the carrier waves is greatly attenuated due to fading and only one of them is received, when the frequency shift of the frequency modulation by the second baseband signal is made smaller than the frequency shift of the frequency modulation by the first baseband signal which is the transmitting signal, the amplitude of the demodulated second baseband signal also becomes small, and in the case of FSK, the baseband signal is converted to a digital signal by a level comparator so that this influence can be made small.

In the case of analog communication and in the case when a simple level comparator such as a multi-value FSK cannot be used, this influence can be eliminated by setting the frequency of the second baseband signal at a value equal to or more than the cutoff frequency of the baseband filter of the receiver.

In the present invention, since the difference in the center frequencies in the modulation between the intermediate frequencies is constantly varied by the second frequency modulation, it is only instantaneous that the difference between the intermediate frequencies becomes within the band of the baseband filter, even though it sometimes does, so that the influence of the beat is not given. Therefore, it is not necessary to keep the center frequency in the modulation of the intermediate frequencies highly stable so that high-precision parts are not used and the circuit can also be simplified.

### BRIEF DESCRIPTION OF THE DRAWINGS

FIG. 1 is a view showing the influence of beat on reception;

FIG. 2 is a view showing the spectrum of carrier waves;

FIG. 3 is a view showing the principle of beat removal;

FIG. 4 is a view showing the relation between frequency shift and a demodulation characteristic;

FIG. 5 is a view showing the structure of a transmitter of the present invention; and

FIG. 6 is a view showing the structure of a receiver of the present invention, respectively.

The reference signs in the drawings denote the following.

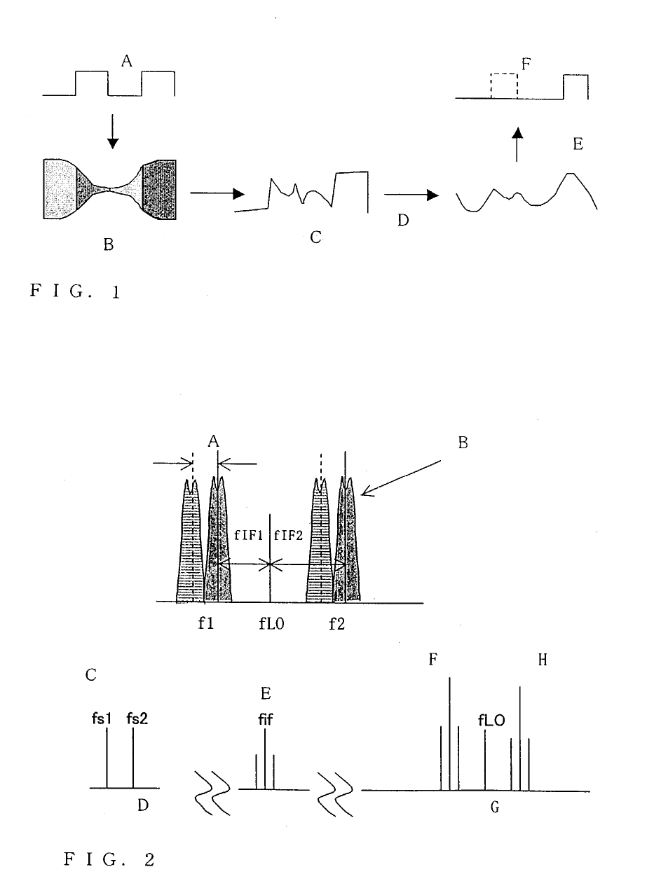

FIG. 1 INFLUENCE OF BEAT ON RECEPTION

A TRANSMISSION BASEBAND SIGNAL

B INTERMEDIATE FREQUENCY AMPLITUDE-MODULATED BY BEAT

C DETECTED OUTPUT

D LOWPASS FILTER

E WAVEFORM SHAPING

F RECEIVING SIGNAL

FIG. 2 SPECTRUM OF CARRIER WAVES

A SECOND FREQUENCY MODULATION

B FIRST FREQUENCY MODULATION

C FIRST BASEBAND SIGNAL

D SECOND BASEBAND SIGNAL

E INTERMEDIATE FREQUENCY

F FIRST CARRIER WAVE f1

G LOCAL FREQUENCY fLO =(f1+f2)/2

H SECOND CARRIER WAVE f2

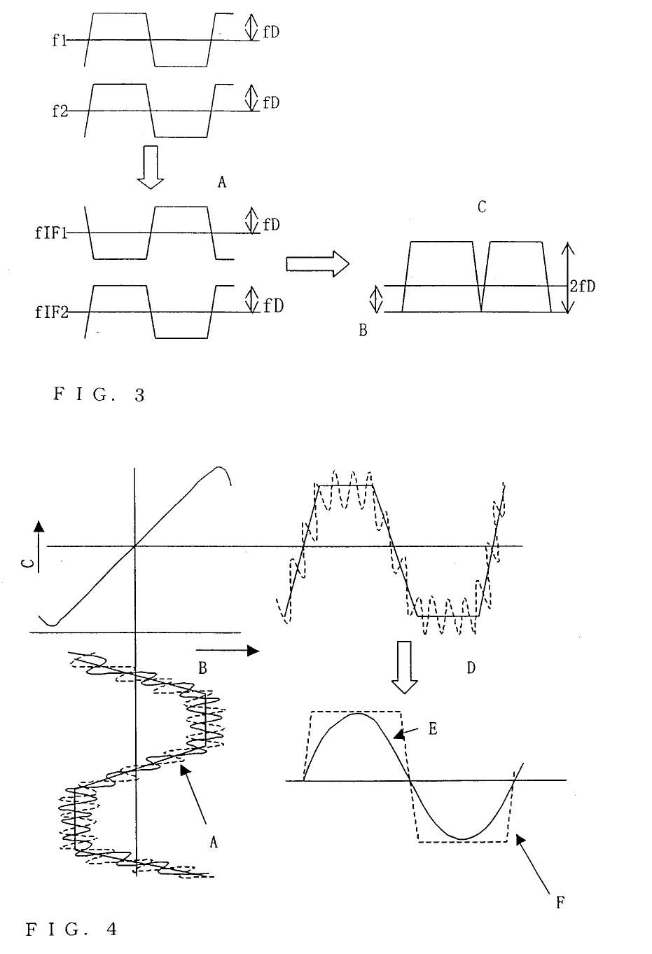

FIG. 3 PRINCIPLE OF BEAT REMOVAL

A FREQUENCY CONVERSION

B BAND OF BASEBAND FILTER

C DIFFERENCE BETWEEN INTERMEDIATE FREQUENCIES fIF1−fIF2

FIG. 4 RELATION BETWEEN FREQUENCY SHIFT AND DEMODULATION CHARACTERISTIC

A COMPONENT OF SECOND FREQUENCY MODULATION IS CANCELLED OUT.

B FREQUENCY

D COMPONENT OF SECOND FREQUENCY MODULATION CAN BE REMOVED BY FILTER OR COMPARATOR EVEN WHEN IT IS LEFT.

E AFTER PASSING BASEBAND FILTER

F AFTER PASSING COMPARATOR

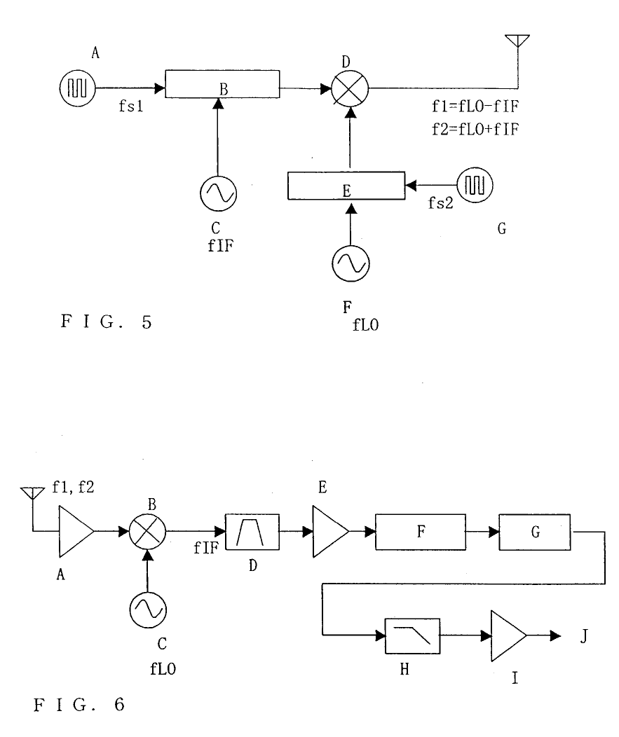

FIG. 5 STRUCTURE OF TRANSMITTER

A TRANSMISSION BASEBAND SIGNAL

B FIRST FM MODULATOR

C INTERMEDIATE FREQUENCY OSCILLATOR

D FREQUENCY CONVERTER

E SECOND FM MODULATOR

F LOCAL OSCILLATOR

G SECOND BASEBAND SIGNAL

FIG. 6 STRUCTURE OF RECEIVER

A HIGH-FREQUENCY AMPLIFIER

B FREQUENCY CONVERTER

C LOCAL OSCILLATOR

D INTERMEDIATE-FREQUENCY FILTER

E INTERMEDIATE-FREQUENCY AMPLIFIER

F LIMITER

G DETECTOR

H LOWPASS FILTER

I LOW-FREQUENCY AMPLIFIER

J BASEBAND OUTPUT

### DETAILED DESCRIPTION OF THE PREFERRED EMBODIMENTS

An example embodied by this applicant will be introduced hereunder. FIG. 5 shows the structure of a transmitter. An intermediate frequency f_{IF} which has undergone frequency modulation by a transmission baseband signal is inputted to a frequency converter to be converted to carrier wave frequencies. Here, assuming that the frequency of a local oscillator is f_{LO}, two frequencies expressed as f_{LO}±f_{IF} are outputted in an output of the frequency converter. Two carrier waves expressed as f_{LO}−f_{IF} and f_{LO}+f_{IF} whose modulation polarities are reverse to each other are obtained by the frequency conversion.

In addition, by frequency-modulating a local signal of the frequency converter by a second baseband signal, the aforesaid two carrier waves are frequency-modulated with the same polarity by the second baseband signal.

FIG. 6 shows the structure of a receiver. This structure itself is completely the same as that of a generally known single super-heterodyne receiver. Assuming that the frequencies of the two carrier waves are f₁ and f₂ and the local frequency of the receiver f_{LO}=(f₁+f₂)/2, the two carrier waves result in having one intermediate frequency f_{IF}=(f₁−f₂)/2 to be synthesized. Since f₁ and f₂ are in an image frequency relation with each other, their modulation polarities become reverse to each other when they are converted to the intermediate frequency, but since the modulation polarity of one of them is made reverse on a transmitting end in advance, the transmission baseband signal is synthesized with the same polarity. On the other hand, the second baseband signal is cancelled out and is not demodulated.

The local frequency of this receiver is the same as that of the local oscillator of the transmitter shown in FIG. 5 so that a local oscillation circuit can be shared by the transmitter and the receiver.

As a concrete example of the transmitter-receiver explained above, a radio transmitter-receiver whose size is 35 mm in width, 25 mm in length, and 5 mm in height including a CPU for controlling has been realized, in which a first baseband signal fₛ₁, =256 Hz (FSK 512 bps), a second baseband signal fₛ₂ =4 kHz and is a square wave, intermediate frequency of transmitting and receiving circuits f_{if}=4.5 MHz, local frequency f_{LO}=312.24 MHz, carrier waves f₂=316.74 MHz and f₁=307.74 MHz, frequency shift of first frequency modulation f_{D1}=25 kHz, frequency shift of second frequency modulation f_{D2}=5 kHz, cutoff frequency of a baseband filter is 300 Hz, and a local oscillation circuit is shared by the transmitting circuit and the receiving circuit.

In a field experiment by the present inventor, the validity of the present invention has been recognized since desensitization due to beat does not occur, and obvious improvement in reception probability is seen compared with that when frequency diversity is not utilized.

Further, it is also the effect of the present invention to be able to realize such a communication function with the outer shape as described above.

Industrial Applicability

The use of the present invention can realize a small-sized and low-priced radio transmitter-receiver which is not easily influenced by fading so that a diversity radio transmitter-receiver with high communication stability can be provided as one electronic component.

This makes it possible to provide a radio function in a device which conventionally has not been able to utilize radio communication due to the restriction on price and a mounting space or because desired communication performance has not been satisfied even if it is low-priced, and therefore, there is a possibility that the radio communication will be used in a wider field.

What is claimed is:

1. A radio transmitter-receiver having a frequency diversity function which utilizes two carrier waves with different frequencies, wherein a transmitter and a receiver have the following functions:
the transmitter has a first frequency modulation function of outputting first and second carrier waves with different frequencies and frequency-modulating these carrier waves with reverse polarities to each other by a transmission baseband signal;
the transmitter has a second frequency modulation function of frequency-modulating said two carrier waves with the same polarity by a second baseband signal except a transmitting signal, in addition to said modulation; and
the receiver frequency-converts said first and second carrier waves to intermediate frequencies whose center frequencies in modulation are equal, wherein this frequency conversion is performed with such a local frequency as to cause modulation polarities by said first frequency modulation to become equal at the intermediate frequency.

2. The radio transmitter-receiver according to claim 1, wherein said second baseband signal is a square wave, and frequency shift of said second frequency modulation and a local frequency of the receiver are so set that a difference in instantaneous frequencies between a first intermediate frequency and a second intermediate frequency which are obtained by the frequency conversion of the first carrier wave and the frequency conversion of the second carrier wave respectively in said receiver becomes higher than a cutoff frequency of a receiving baseband filter during a time period except a time period of level shift of the square wave.

3. The radio transmitter-receiver according to claim 1, wherein a frequency of said second baseband signal is set higher than a cutoff frequency of a baseband filter of the receiver.

4. The radio transmitter-receiver according to claim 1, wherein frequency shift of said second frequency modulation is made smaller than that of said first frequency modulation.
